(19) United States
(12) Patent Application Publication
(10) Pub. No.: US 2024/0123541 A1
(43) Pub. Date: Apr. 18, 2024

(54) STRUCTURE AND METHOD OF MANUFACTURING STRUCTURE

(71) Applicants: SONY GROUP CORPORATION, Tokyo (JP); TOHOKU UNIVERSITY, Miyagi (JP)

(72) Inventors: Shohei ABE, Tokyo (JP); Yuichi TAKAHASHI, Tokyo (JP); Takehito SHIMATSU, Miyagi (JP); Miyuki UOMOTO, Miyagi (JP)

(73) Assignees: SONY GROUP CORPORATION, Tokyo (JP); TOHOKU UNIVERSITY, Miyagi (JP)

(21) Appl. No.: 18/263,919

(22) PCT Filed: Dec. 20, 2021
(86) PCT No.: PCT/JP2021/047009

§ 371 Date: Aug. 2, 2023

(30) Foreign Application Priority Data
Feb. 10, 2021 (JP) 2021-019787

(51) Int. Cl. B23K 20/02; B23K 20/16; B32B 7/10; B32B 9/04; B32B 38/00

(52) U.S. Cl. CPC B23K 20/026; B23K 20/16; B32B 7/10; B32B 9/041; B32B 38/0036; B23K 2103/52; B32B 2250/05; B32B 2250/40; B32B 2307/40; B32B 2307/538

(57) ABSTRACT

A structure according to an embodiment of the present disclosure include: a first base; a second base disposed to be opposed to the first base; and a bonding layer that is provided between the first base and the second base, and includes, in a layer, a layer including a first metal element and a second metal element, the first metal element having a free energy of oxide formation (ΔG) of −330 (kJ/mol of compounds) or more at room temperature and a self-diffusion coefficient (D) of 1×10⁻⁵⁵ (m²/s) or more at room temperature, and the second metal element having a free energy of oxide formation (ΔG) at room temperature smaller than the free energy of oxide formation (ΔG) at the room temperature of the first metal element.

### TECHNICAL FIELD

The present disclosure relates to a structure bonded with use of, for example, atomic diffusion bonding, and a method of manufacturing the structure.

### BACKGROUND ART

For example, PTL 1 discloses an atomic diffusion bonding method. In the atomic diffusion bonding method, bonding films including a metal, except for gold (Au) or an Au alloy, that have a predetermined value or more of a volume diffusion coefficient are formed on respective smooth surfaces of a pair of bases, protective films having a microcrystalline structure including Au or an Au alloy are further formed on the bonding films, and the protective films are superimposed on each other in an atmosphere at pressure including atmospheric pressure exceeding 1×10⁻⁴ Pa to bond the pair of bases. In addition, for example, PTL 2 discloses a method in which silicon oxide (Sift) films are formed as bonding layers on respective smooth surfaces of a pair of bases, metal tilt s are further formed in high vacuum, and thereafter respective protective films are superimposed on each other to bond the pair of bases, and annealing treatment is further performed to transparentize the bonding layers.

### CITATION LIST

### Patent Literature

PTL 1: Japanese Unexamined Patent Application Publication No. 2016-087664
PTL 2: International Publication No. WO2019/138875

### SUMMARY OF THE INVENTION

Incidentally, for example, light resistance is demanded in an optical part, such as a lens and a prism, used for, for example, a projector including a laser light source. Accordingly, an attempt has been made to apply the above-described atomic diffusion bonding technology without using an adhesive, and development of an inexpensive atomic diffusion bonding method that enables alignment is demanded.

It is desirable to provide a structure and a method of manufacturing a structure that are inexpensive and make it possible to improve alignment properties.

A structure according to an embodiment of the present disclosure includes: a first base; a second base disposed to be opposed to the first base; and a bonding layer that is provided between the first base and the second base, and includes, in a layer, a layer including a first metal element and a second metal element, the first metal element having a free energy of oxide formation (ΔG) of −330 (kJ/mol of compounds) or more at room temperature and a self-diffusion coefficient (D) of 1×10⁻⁵⁵ (m²/S) or more at room temperature, and the second metal element having a free energy of oxide formation (ΔG) at room temperature smaller than the free energy of oxide formation (ΔG) at the room temperature of the first metal element.

A method of manufacturing a structure according to an embodiment of the present disclosure includes: forming an oxygen supply layer including an oxide material on each of one surface of a first base and one surface of a second base; forming a second metal layer including a second metal element on each of the oxygen supply layer on side of the first base and the oxygen supply layer on side of the second base, the second metal element having a free energy of oxide formation (ΔG) smaller than −330 (kJ/mol of compounds) at room temperature; forming a first metal layer including a first metal element on each of the second metal layer on the side of the first base and the second metal layer on the side of the second base, the first metal element having a free energy of oxide formation (ΔG) of −330 (kJ/mol of compounds) or more at room temperature and a self-diffusion coefficient (D) of 1×10⁻⁵⁵ (m²/s) or more at room temperature; and superimposing the first metal layers on the side of the first base and the side of the second base and performing heating and pressurization in the atmosphere.

In the structure according to the embodiment of the present disclosure and the method of manufacturing the structure according to the embodiment of the present disclosure, the oxygen supply layer including the oxide material, the second metal layer including the second metal element having a free energy of oxide formation (ΔG) of smaller than −330 (kJ/mol of compounds) at room temperature, and the first metal layer including the first metal element having a free energy of oxide formation (ΔG) of −330 (kJ/mol of compounds) or more at room temperature and a self-diffusion coefficient (D) of 1×10⁻⁵⁵ (m²/s) at room temperature are formed in order on each of one surface (a bonding surface) of the first base and one the second base, and the first metal layers on the side of the first base and the side of the second base are superimposed on each other, and heating and pressurization are performed in the atmosphere. Accordingly, replacement and diffusion occur between the second metal layer and the first metal layer, and the second metal element is oxidized by oxygen released from the oxygen supply layer to transparentize the bonding layer.

### BRIEF DESCRIPTION OF DRAWINGS

FIG. 1 is a schematic cross-sectional view of a configuration of a structure according to an embodiment of the present disclosure.

FIG. 2 is a diagram illustrating a relationship between free energies of oxide formation and self-diffusion coefficients for various kinds of metals.

FIG. 3A is a schematic cross-sectional view of an example of a method of manufacturing the structure illustrated in FIG. 1.

FIG. 3B is a schematic cross-sectional view of a process subsequent to FIG. 3A.

FIG. 3C is a schematic cross-sectional view of a process subsequent to FIG. 3B.

FIG. 4 is a schematic cross-sectional view of a configuration of a structure according to a modification example of the present disclosure.

FIG. 5A is a schematic cross-sectional view of an example of a method of manufacturing the structure illustrated in FIG. 4.

FIG. 5B is a schematic cross-sectional view of a process subsequent to FIG. 5A.

FIG. 5C is a schematic cross-sectional view of a process subsequent to FIG. 5B.

FIG. 6 is a characteristic diagram illustrating change in transparentization of a bonding layer by annealing treatment in Example 1.

FIG. 7 is a characteristic diagram illustrating change in transparentization of a bonding layer by annealing treatment in Example 2.

FIG. 8 is a characteristic diagram illustrating change in transparentization of a bonding layer by annealing treatment in Example 3.

FIG. 9 is a characteristic diagram illustrating change in transparentization of a bonding layer by annealing treatment in Example 4.

FIG. 10 is a characteristic diagram illustrating change in transparentization of a bonding layer by annealing treatment in Example 5.

### MODES FOR CARRYING OUT THE INVENTION

In the following, some embodiments of the present disclosure are described in detail with reference to the drawings. The following description is given of specific examples of the present disclosure, and the present disclosure is not limited to the following embodiments. Moreover, the present disclosure is not limited to positions, dimensions, dimension ratios, and the like of respective components illustrated in the respective drawings. It is to be noted that description is given in the following order.
1. Embodiment (An example of a structure in which a pair of bases are bonded with a bonding layer including two kinds of metal elements interposed therebetween)
1-1. Configuration of Structure
1-2. Method of Manufacturing Structure
1-3. Workings and Effects
2. Modification Example (An example in which a silicon oxide layer and a metal layer of a first metal element are formed on each of the pair of bases and bonding is performed)
3. Examples

### 1. EMBODIMENT

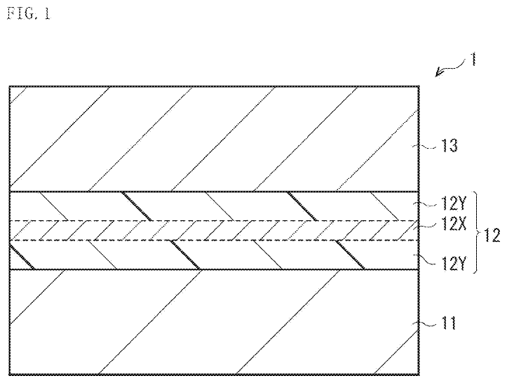

FIG. 1 schematically illustrates a cross-sectional configuration of a structure (a structure 1) according to an embodiment of the present disclosure. This structure 1 is a bonded body in which two or more members to be bonded are bonded by, for example, atomic diffusion bonding, and examples thereof include optical parts such as a cemented lens and a prism. The structure 1 according to the present embodiment includes, for example, a pair of bases (a base 11 and a base 13) that have light transmittance and are bonded by a bonding layer 12 including two kinds of metal elements.

### (1-1. Configuration of Structure)

The structure 1 includes the base 11 and the base 13 bonded by, for example, atomic diffusion bonding, and has a configuration in which the base 11, the bonding layer 12, and the base 13 are stacked in this order.

The base 11 is a plate-like member having one surface and another surface opposed to each other, and corresponds to a specific example of a “first base” of the present disclosure. The base 11 includes, for example, an inorganic material or a plastic material having light transmittance.

Examples of the inorganic material included in the base 11 include silicon oxide, silicon nitride, sapphire, diamond, silicon, a GaAs compound, and a YAG compound. Examples of the silicon oxide include glass, spin-on glass (SOG), crystal, and the like. Examples of the plastic material include polycarbonate (PC), polyethylene terephthalate (PET), polyethylene naphthalate (PEN), acrylic (PMMA), cycloolefin polymer (COP), polyether ether ketone (PEEK), and the like.

The bonding layer 12 is a layer that has light transmittance and bonds the base 11 and the base 13, and corresponds to a specific example of a “bonding layer” of the present disclosure. The bonding layer 12 includes two kinds of metal elements (a first metal element and a second metal element) as described above. The two kinds of metal elements have free energies of oxide formation different from each other. Specifically, the bonding layer 12 includes a region (a layer) containing, in a layer, the first metal element and the second metal element in higher concentrations than in another region. More specifically, as described in detail later, the bonding layer 12 includes a metal oxide layer 12X containing the first metal element and the second metal element in high concentrations, and an oxide layer 12Y, and the metal oxide layer 12X is formed between the oxide layers 12Y provided, for example, on side of the base 11 and side of the base 13. In the metal oxide layer 12X, the second metal element is present as an oxide, and the first metal element is diffused into the oxide of the second metal element. As described in detail later, depending on a heating temperature, the first metal element is diffused, for example, throughout the metal oxide layer 12X, and is diffused to the oxide layer 12Y near the metal oxide layer 12X, or into the oxide layer 12Y.

The first metal element and the second metal element each have the following properties. The first metal element has a free energy of oxide formation (ΔG) of −330 (kJ/mol of compounds) or more at room temperature, and a self-diffusion coefficient (D) of 1×10⁻⁵⁵ (m²/s) or more at room temperature. The second metal element has a free energy of oxide formation smaller than that of the first metal element, that is, a free energy of oxide formation (ΔG) smaller than −330 (kJ/mol of compounds) at room temperature.

It is to be noted that all values of the free energies of oxide formation (ΔG) and the self-diffusion coefficients (D) listed below are values at room temperature (300 K), and the term “at room temperature” is omitted.

FIG. 2 illustrates a relationship between free energies of oxide formation and self-diffusion coefficients for various kinds of metals. Table 1 summarizes composition formulas of oxides of the metals listed in FIG. 2, the self-diffusion coefficients (volume diffusion) D, and free energies of formation ΔG (kJ/mol of compounds) of metal oxides. It is to be noted that the self-diffusion coefficients (volume diffusion) D in FIG. 2 and Table 1 are values at 300 K (room temperature), and are determined by calculation of self-diffusion in pure metals described in Metal Data Book, 3rd edition (edited by The Japan Institute of Metals and Materials) with use of a pre-exponential factor DO and activation energy Q. Note that the self-diffusion coefficients D of silicon (Si), gallium (Ga), and germanium (Ge) are not described in the Metal Data Book, and are therefore determined similarly from the literature (Smithells Metals Reference Book, 7th Edition (Edited by E. A. Brandes and G. B. Brook) Butterworth Heinemann Table 13.1e, p. 13-10). The free energies of formation ΔG (kJ/mol of compounds) of the metal oxides listed in FIG. 2 and Table 1 are values at 300 K (room temperature), and are cited from values described in the literature (Smithells Metals Reference Book, 7th Edition (Edited by E. A. Brandes and G. B. Brook) Butterworth Heinemann Table 8.8e, pp. 8-25 to 27). Among them, the value of silicon oxide (SiO₂) is an extrapolated value based on values at 1000 K and 1500 K. Note that platinum (Pt) and gold (Au) are not oxidized at room temperature, and ΔG of each of Pt and Au is positive and is not therefore determined. In FIG. 2, ΔG of each of Pt and Au is a positive value, and is therefore simply illustrated in a positive region.

TABLE 1

| Metal | Oxide | D (300 K) | ΔG (300 K) |
|---|---|---|---|
| Al | Al₂O₃ | 3.2E−29 | −1584 |
| Si | SiO₂ | 1.3E−36 | −848.6 |
| Sc | Sc₂O₃ | no date | −1818.7 |
| Ti | Ti₂O₃ | 6.6E−36 | −1427.1 |
| | Ti₃O₅ | 6.6E−36 | −2309.4 |
| | TiO₂ | 6.6E−36 | −862.1 |
| V | VO₂ | 8.5E−59 | −678.4 |
| | V₂O₃ | 8.5E−59 | −1147 |
| | V₂O₅ | 8.5E−59 | −1454.1 |
| Cr | Cr₂O₃ | 4.7E−59 | −1051.3 |
| Co | Co₃O₄ | 5.0E−52 | −777.1 |
| Ni | NiO | 1.5E−53 | −213.1 |
| Cu | Cu₂O | 1.4E−41 | −144.9 |
| Zn | ZnO | 3.2E−22 | −320.7 |
| Ga | Ga₂O₃ | 5.0E−17 | −992.3 |
| Ge | GeO₂ | 1.0E−55 | −525.3 |
| Y | Y₂O₃ | 6.2E−53 | −1817.9 |
| Zr | ZrO₂ | 4.4E−31 | −1042.2 |
| Nb | Nb₂O₅ | 1.1E−74 | −1766 |
| Mo | MoO₃ | 6.2E−73 | −668.6 |
| Pd | PdO | 1.0E−51 | −82.2 |
| Ag | Ag₂O | 8.3E−38 | −10.68 |
| In | In₂O₃ | 9.0E−18 | −834 |
| Sn | SnO₂ | 3.3E−22 | −519.4 |
| Hf | HfO₂ | 7.2E−66 | −1053.4 |
| Ta | Ta₂O₅ | 1.5E−77 | −1910.9 |
| W | WO₃ | 6.7E−110 | no date |
| Pt | PtO₂ | 8.7E−54 | >0 |
| Au | Au₂O₃ | 1.6E−36 | >0 |

Numerical values of free energies of formation (ΔG) and self-diffusion coefficients (D) for oxides to identify the first metal element and the second metal element described above are based on the following.

The first metal element plays an important role in bonding the base 11 and the base 13. For example, to cause sufficient atomic diffusion (atomic rearrangement) at a contact interface to bond the base 11 and the base 13, the self-diffusion coefficient (D) needs a certain magnitude or greater. An element having the smallest self-diffusion coefficient (D) among single metals having the properties of the first metal element is platinum (Pt), of which the self-diffusion coefficient (D) is 8.7×10⁻⁵⁴ (m²/s). Major alloys including Pt as a principal component include a Pt—Ni alloy as the first metal element having a self-diffusion coefficient (D) smaller than that of Pt. The self-diffusion coefficient (D) of the Pt—Ni alloy estimated from a difference in melting point with Pt is a value in a 10⁻⁵⁵ (m²/s) range that is slightly smaller than that of Pt. It is therefore sufficient that the self-diffusion coefficient (D) of the first metal element is 1×10⁻⁵⁵ (m²/s) or more.

Meanwhile, to perform bonding in the atmosphere, it is desirable that the first metal element bean element having a weak bonding force to oxides. That is, it is desirable that the free energy of oxide formation (ΔG) indicating an energy change amount upon bonding to oxygen have a certain magnitude or greater. As described in detail later, a single metal having the smallest free energy of oxide formation (ΔG) among the metals having properties of the first metal element is zinc (Zn), and the free energy of oxide formation (ΔG) in a case where zinc oxide (ZnO) is generated from Zn is −320.7 (kJ/mol of compounds)). An alloy in which a slight amount of gallium (Ga) or aluminum (Al) is added to Zn also has the properties of the first metal element. The magnitudes of ΔG of oxides of these alloys are not defined; however, Ga and Al are material easily combining with oxygen. For this reason, ΔG of each of oxides of these alloys is slightly lower than that in a case where ZnO is generated from Zn. It is therefore sufficient that the free energy of oxide formation (ΔG) of the first metal element is −330 (kJ/mol of compounds)) or more.

Specific examples of the first metal element include nickel (Ni), palladium (Pd), platinum (Pt), copper (Cu), silver (Ag), gold (Au), and zinc (Zn). By using Ni, Pd, Pt, Cu, and Zn having a free energy of oxide formation (ΔG) of less than −10.68 (kJ/mol of compounds) and a self-diffusion coefficient (D) of less than 8.3×10⁻³ (m²/s) among the metal elements described above, alignment properties upon bonding the base 11 and the base 13 are improved. Specific examples of the second metal element include scandium (Sc), titanium (Ti), vanadium (V), chromium (Cr), yttrium (Y), zirconium (Zr), niobium (Nb), molybdenum (Mo), lanthanum (La), cerium (Ce), hafnium (Hf), tantalum (Ta), tungsten (W), aluminum (Al), and silicon (Si).

The oxide layer 12Y supplies oxygen for oxidizing the second metal element, and corresponds to a specific example of an “oxygen supply layer” of the present disclosure. The oxide layer 12Y includes, for example, a material that is able to supply oxygen, e.g., an inorganic material (inorganic oxide) combined with oxygen. Specific examples of the oxide layer 12Y include silicon oxide (SiO₂) and the like. It is to be noted that SiO₂ here indicates a stoichiometric composition, and includes SiO₂ in which oxygen deficiency occurs and SiO₂ in which supersaturated oxygen is included due to a chemical or physical factor. This applies to a case where any other oxide is represented by a chemical symbol.

A film thickness in a stacking direction (hereinafter simply referred to as thickness) of the bonding layer 12 is, for example, greater than or equal to 10 nm and less than or equal to 10 μm. In the bonding layer 12, the metal oxide layer 12X has a thickness of greater than or equal to 0.2 nm and less than or equal to 30 nm.

The base 13 is, for example, a plate-like member having one surface and another surface opposed to each other, and corresponds to a specific example of a “second base” of the present disclosure. The base 13 includes, for example, an inorganic material or a plastic material having light transmittance.

As with the base 11, examples of the inorganic material included in the base 13 include silicon oxide, silicon nitride, sapphire, diamond, silicon, a GaAs compound, and a YAG compound. Examples of silicon oxide include glass, spin-on glass (SOG), crystal, and the like. Examples of the plastic material include polycarbonate (PC), polyethylene terephthalate (PET), polyethylene naphthalate (PEN), acrylic (PMMA), cycloolefin polymer (COP), polyether ether ketone (PEEK), and the like.

### (1-2. Method of Manufacturing Structure)

It is possible to manufacture the structure 1 as follows.

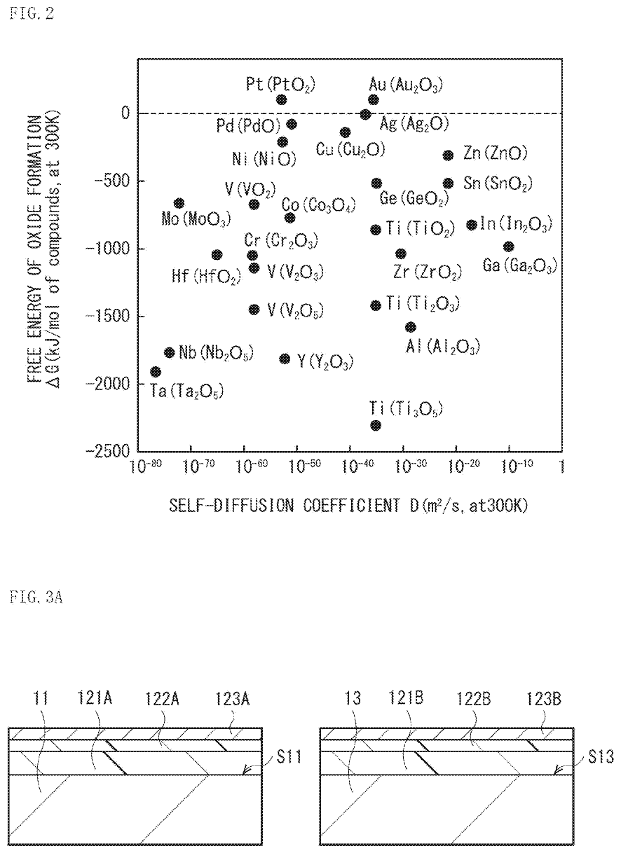

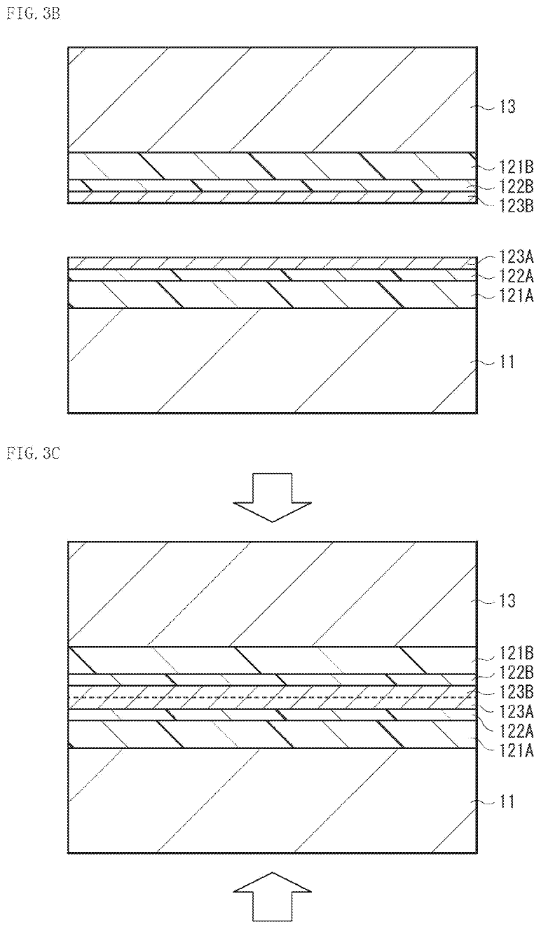

First, as illustrated in FIG. 3A, silicon oxide layers 121A and 121B are respectively formed as base layers on bonding surfaces (a surface S11 and a surface S13) of the base 11 and the base 13, and are thereafter polished to, for example, arithmetic mean roughness (Ra) of <1 nm or less. Subsequently, as illustrated in FIG. 3A, Ti films are respectively formed as second metal layers 122A and 122B with, for example, a thickness of 5 nm on the silicon oxide layers 121A and 121B by, for example, sputtering under a vacuum condition. Next, as illustrated in FIG. 3A, Cu films are respectively formed as the first metal layers 123A and 123B with, for example, a thickness of 2 nm on the second metal layers 122A and 122B by, for example, sputtering under the vacuum condition. It is to be noted that the second metal layers 122A and 122B and the first metal layers 123A and 123B are successively formed without taking them out into the atmosphere.

Subsequently, the base 11 and the base 13 are taken out into the atmosphere, and are disposed to be opposed to each other with the first metal layer 123A and the first metal layer 123B opposed to each other, as illustrated in FIG. 3B. Next, as illustrated in FIG. 3C, the first metal layers 123A and 123B are brought into contact with each other in the atmosphere, and heating and pressurization are performed, for example, at 5 GPa and 200° C. Thus, the first metal layer 123A and the first metal layer 123B are bonded. It is to be noted that the pressurization condition and the heating condition described above are examples, and these conditions vary depending on surface roughness and materials of bonding surfaces.

Thereafter, a bonded body is annealed under a high temperature condition (e.g., 200° C. or higher), for example. This causes Cu atoms included in the first metal layers 123A and 123B to be diffused into the second metal layers 122A and 122B and replaced by Ti atoms included in the second metal layers 122A and 122B. At the same time, Ti atoms are oxidized by oxygen released from the silicon oxide layers 121A and 121B to become a dielectric, thereby eliminating reflection and absorption. That is, the transparent bonding layer 12 including a titanium oxide layer (the metal oxide layer 12X) into which Cu atoms are similarly diffused is formed. In addition, the bonding layer 12 is insulated. Here, a state in which Cu atoms (the first metal element) are diffused in the second metal layers 122A and 122B is an oxide of an alloy including the first metal element and the second metal element in which Cu atoms are dissolved to some extent in titanium oxide (an oxide of the second metal element) included in the metal oxide layer 12X, that is, a mall amount of the first metal element is included, and is close to a state in which the first metal element that cannot be dissolved is finely precipitated and dispersed as a metal.

It is to be noted that the bonded body is annealed under a higher temperature condition (e.g., 500° C.), which causes Cu atoms to be diffused, for example, throughout the second metal layers 122A and 122B (the metal oxide layer 12X), and causes some of the Cu atoms to be diffused to the silicon oxide layers 121A and 121B (the oxide layer 12Y) near the metal oxide layer 12X or into the silicon oxide layers 121A and 121B (the oxide layer 12Y). This promotes transparentization of the bonding layer 12.

### (1-3. Workings and Effects)

For the structure 1 according to the present embodiment, the silicon oxide layers 121A and 121B are respectively formed on the bonding surfaces (the surface S11 and the surface S13) of the base 11 and the base 13, and thereafter the second metal layers 122A and 122B including the second metal element having a free energy of oxide formation (ΔG) smaller than −330 (kJ/mol of compounds) at room temperature, and the first metal layers 123A and 123B including the first metal element having a free energy of oxide formation (ΔG) of −330 (kJ/mol of compounds) or more at room temperature and a self-diffusion coefficient (D) of 1×10⁻⁵⁵ (m²/s) or more at room temperature are successively formed under a vacuum condition. Accordingly, after that, the base 11 and the base 13 are bonded by heating and pressurization in the atmosphere. Furthermore, this bonded body is subjected to annealing treatment under a high temperature condition (200° C. or higher) to cause atoms of the first metal element to be diffused into the second metal layers 122A and 122B and replaced by the second metal element included in the second metal layers 122A and 122B. At the same time, the second metal element is oxidized by oxygen released from the silicon oxide layers 121A and 121B. This transparentizes the bonding layer 12 that bonds the base 11 and the base 13. This is described below.

As described above, an atomic diffusion bonding method has been disclosed in which, bonding films including a metal that has a predetermined value or more of a volume diffusion coefficient, and protective films having a microcrystalline structure including Au or an Au alloy are formed in order on respective smooth surfaces of a pair of base, and the pair of bases are bonded, for example, by heating and pressurization in the atmosphere. However, in the atomic diffusion bonding method described above, a film of a metal (e.g., gold (Au)) formed as a bonding film on a bonding surface develops a color, and application thereof is therefore limited.

Meanwhile, in an atomic diffusion bonding method in which a silicon oxide (SiO₂) film and a metal film are formed in this order as bonding layers on each of the smooth surfaces of the pair of bases described above and bonding and annealing treatment are performed in high vacuum, the bonding layers are transparentized, but there is an issue that an expensive ultrahigh vacuum facility and long processing time are necessary.

In contrast, in the structure 1 according to the present embodiment, the silicon oxide layers 121A and 121B are respectively formed on the bonding surfaces (the surface S11 and the surface S13) of the base 11 and the base 13, and thereafter the second metal layers 122A and 122B including the second metal element having a free energy of oxide formation (ΔG) smaller than −330 (kJ/mol of compounds) at room temperature, and the first metal layers 123A and 123B including the first metal element having a free energy of oxide formation (ΔG) of −330 (kJ/mol of compounds) or more at room temperature and a self-diffusion coefficient (D) of 1×10⁻⁵⁵ (m²/s) or more at room temperature are successively formed under a vacuum condition. Accordingly, after that, the base 11 and the base 13 are bonded by heating and pressurization in the atmosphere. Furthermore, after that, the bonded body is subjected to annealing treatment under a high temperature condition (200° C. or higher) to cause atoms of the first metal element to be diffused into the second metal layers 122A and 122B. At the same time, the second metal element is replaced by the first metal element to be gathered in portions of the first metal layers 123A and 123B and oxidized by oxygen released from the silicon oxide layers 121A and 121B. Thus, in a layer of the bonding layer 12 that bonds the base 11 and the base 13, the metal oxide layer 12X containing the first metal element and the second metal element in higher concentrations than in another region (e.g., the oxide layer 12Y derived from the silicon oxide layers 121A and 121B) is formed, and the bonding layer 12 loses free electrons responding to electromagnetic waves, thereby being transparentized.

As described above, in the structure 1 according to the present embodiment, the ultrahigh vacuum facility is not necessary as compared with a transparent bonding technology using the ultrahigh vacuum facility descried above, which makes it possible to bond members to be bonded at lower cost. In addition, it is possible to bond the members to be bonded for a short time. Furthermore, in the present embodiment, the members to be bonded are bonded in the atmosphere, which makes it possible to use an alignment apparatus that is difficult to be installed in the ultrahigh vacuum facility. Accordingly, it is possible to perform bonding after alignment, which makes it possible to improve bonding position accuracy.

Furthermore, using Ni, Pd, Pt, Cu, and Zn having a free energy of oxide formation (ΔG) of less than −10.68 (kJ/mol of compounds) at room temperature and a self-diffusion coefficient (D) of less than 8.3×10⁻³⁸ (m²/s) at room temperature among the first metal elements described above makes it possible to perform alignment at ordinary temperature. This makes it possible to improve alignment properties upon bonding the base 11 and the base 13 and further improve bonding position accuracy.

In addition, in the present embodiment, the bonding layer 12 is transparentized by annealing treatment after bonding, which makes it possible to apply the manufacturing method according to the present embodiment to manufacturing of an optical part such as a cemented lens and a prism, and makes it possible to improve durability of the optical part.

A modification example and examples of the present embodiment are described below, and in the following description, the same components as those of the embodiment described above are denoted with the same reference numerals, and the description thereof is omitted as appropriate.

### 2. MODIFICATION EXAMPLE

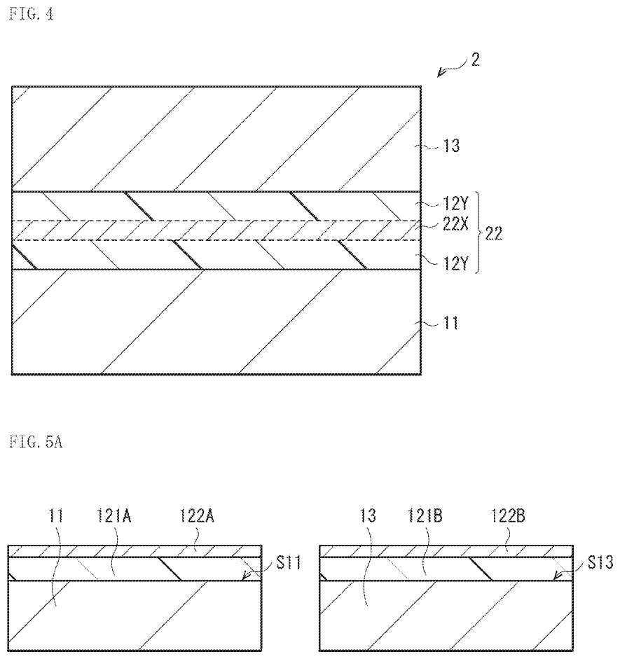

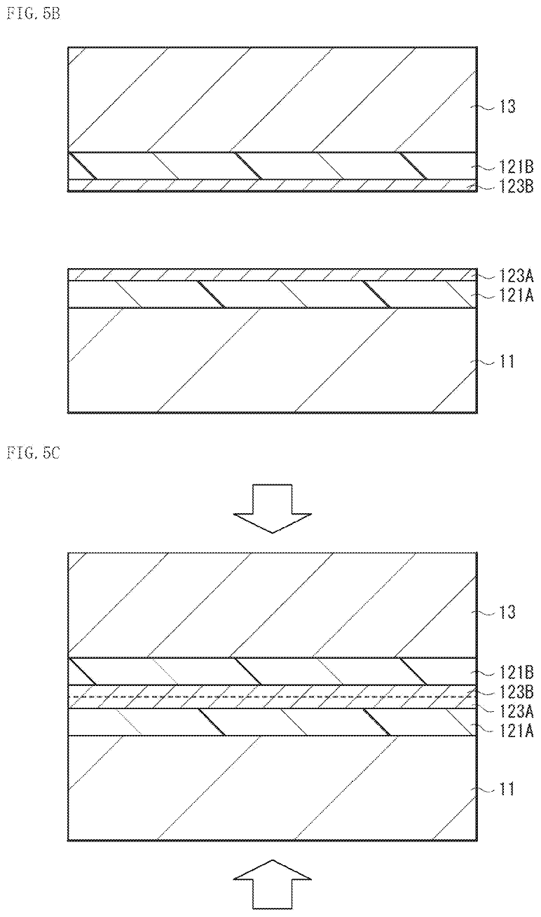

FIG. 4 schematically illustrates a cross-sectional configuration of a structure (a structure 2) according to a modification example of the present disclosure. As with the structure 1 according to the embodiment described above, the structure 2 is a bonded body in which two or more members to be bonded are bonded by, for example, atomic diffusion bonding, and examples thereof include optical parts such as a cemented lens and a prism. The structure 2 according to the present modification example differs from the embodiment described above in that the second metal layers 122A and 122B are omitted, oxide layers (the silicon oxide layers 121A and 121B) are respectively formed on the bonding surfaces (the surface S11 and the surface S13) of the base 11 and the base 13, first metal layers 123A and 123B are respectively provided on the silicon oxide layers 121A and 121B, and bonding is performed (for example, refer to FIG. 5A).

The structure 2 includes the base 11 and the base 13 bonded by, for example, atomic diffusion bonding, and has a configuration in which the base 11, the bonding layer 22, and the base 13 are stacked in this order.

The bonding layer 22 is a layer that has light transmittance and bonds the base 11 and the base 13. The bonding layer 22 includes a metal oxide layer 22X including an oxide of the first metal element between the oxide layers 12Y provided on side of the base 11 and side of the base 13. It is possible to manufacture the structure 2 as follows, for example.

First, as illustrated in FIG. 5A, the silicon oxide layers 121A and 121B are respectively formed as base layers on the bonding surface (the surface S11) of the base 11 and the bonding surface (the surface S13) of the base 13, and are thereafter polished to, for example, arithmetic mean roughness (Ra) of <1 nm or less. Next, as illustrated in FIG. 5A, Cu films are formed as the first metal layers 123A and 123B with, for example, a thickness of 1 nm by, for example, sputtering under a vacuum condition.

Subsequently, the base 11 and the base 13 are taken out into the atmosphere, and are disposed to be opposed to each other with the first metal layers 123A and 123B opposed to each other, as illustrated in FIG. 5B. Next, as illustrated in FIG. 5C, the first metal layers 123A and 123B are brought into contact with each other in the atmosphere, and heating and pressurization are performed, for example, at 5 GPa and 200° C. Thus, the first metal layer 123A and the first metal layer 123B are bonded. It is to be noted that the pressurization condition and the heating condition described above are examples, and these conditions vary depending on surface roughness and materials of bonding surfaces of the base 11 and the base 13.

Thereafter, a bonded body is annealed, for example, at 200° C. or higher to cause Cu atoms included in the first metal layers 123A and 123B to be oxidized by outgassing from the silicon oxide layers 121A and 121B, which promotes transparentization of the bonding layer 12. In addition, the bonding layer 22 is insulated. Furthermore, the Cu atoms are diffused into the silicon oxide layers 121A and 121B by annealing, for example, at 500° C. or higher. Accordingly, transmittance of the bonding layer 22 is improved, and the bonding layer 22 is transparentized.

As described above, in the present modification example, the silicon oxide layers 121A and 121B are respectively formed as base layers on the bonding surfaces (the surface S11 and the surface S13) of the base 11 and the base 13, and the first metal layers 123A and 123B are respectively formed on the silicon oxide layers 121A and 121B. Even in this case, the ultrahigh vacuum facility is not necessary as compared with the transparent bonding technology using the ultrahigh vacuum facility descried above, which makes it possible to bond members to be bonded at lower cost. In addition, it is possible to bond the members to be bonded for a short time. Furthermore, in the present embodiment, the members to be bonded are bonded in the atmosphere, which makes it possible to use an alignment apparatus that is difficult to be installed in the ultrahigh vacuum facility. Accordingly, it is possible to perform bonding after alignment, which makes it possible to improve bonding position accuracy. In addition, it is possible to improve durability of an optical part such as a cemented lens and a prism manufactured with use of the manufacturing method according to the present modification example.

It is to be noted that in the embodiment described above and the present modification example, an example in which the silicon oxide layers 121A and 121B are used as the oxide layer 12Y has been described; however, it is sufficient that the oxide layer 12Y is a layer that supplies oxygen (a layer that releases oxygen), and the oxide layer 12Y is not limited to a silicon oxide layer. As long as the oxide layer 12Y is an oxide layer of the second metal element described above, other than the silicon oxide layer, it is possible to effectively diffuse the first metal element into the same layer. As one example, the oxide layer 12Y may include a mixed film of silicon oxide and niobium oxide for optical refractive index adjustment.

### 3. EXAMPLES

Next, the examples of the present disclosure are described in detail below.

### Example 1

First, a silicon oxide (SiO₂) film was formed as a base layer on each of a pair of synthetic quartz substrates with ϕ 2 inches, and thereafter, a surface of the SiO₂ film was polished to arithmetic mean roughness (Ra) of <0.3 nm or less in the atmosphere. Subsequently, a titanium (Ti) film (a thickness of 1 nm) and a copper (Cu) film (a thickness of 1 nm) were formed as metal layers in this order under an ultrahigh vacuum condition. Thereafter, the Cu films provided on the pair of synthetic quartz substrates were coordinated to be opposed to each other, and were bonded by heating and pressurization in the atmosphere at 5 GPa and 200° C. Thereafter, a thus-boned body was subjected to annealing treatment to form an evaluation sample.

### Example 2

In Example 2, an evaluation sample was formed with use of a method similar to that in Example 1 described above, except that a Ti film (a thickness of 5 nm) and a Cu film (a thickness of 5 nm) were formed as metal layers.

### Example 3

In Example 3, an evaluation sample was formed with use of a method similar to that in Example 1 described above, except that a Ti film (a thickness of 10 nm) and a platinum (Pt) film (a thickness of 1 nm) were formed as metal layers.

### Example 4

In Example 4, an evaluation sample was formed with use of a method similar to that in Example 1 described above, except that a Ti film (a thickness of 10 nm) and a gold (Au) film (a thickness of 1 nm) were formed as metal layers.

### Example 5

In Example 5, an evaluation sample was formed with use of a method similar to that in Example 1 described above, except that a Ti film (a thickness of 10 nm) and a nickel (Ni) film (a thickness of 1 nm) were formed as metal layers.

### (Evaluation of Change in Transparentization by Annealing)

The evaluation samples formed in Examples 1 to 5 were heated in order of 300° C. for 1 h, 400° C. for 1 h, 500° C. for 1 h, and 550° C. for 1 h or 550° C. for 12 h, and transmittance measurement was performed. For the transmittance measurement, a spectroscope U-4000 was used, and average transmittance to a wavelength of 440 nm to 660 nm including reflection by an incident/exit surface was measured.

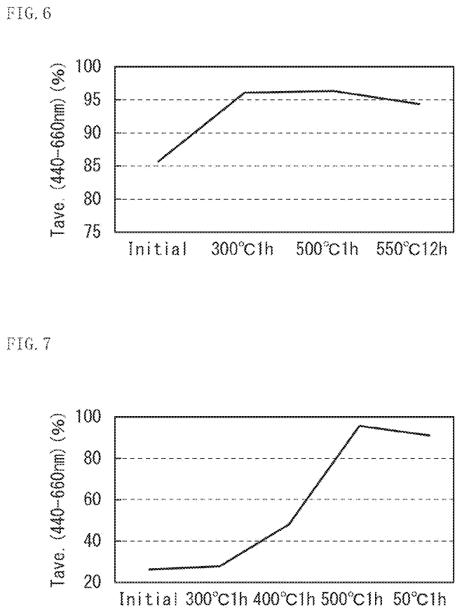

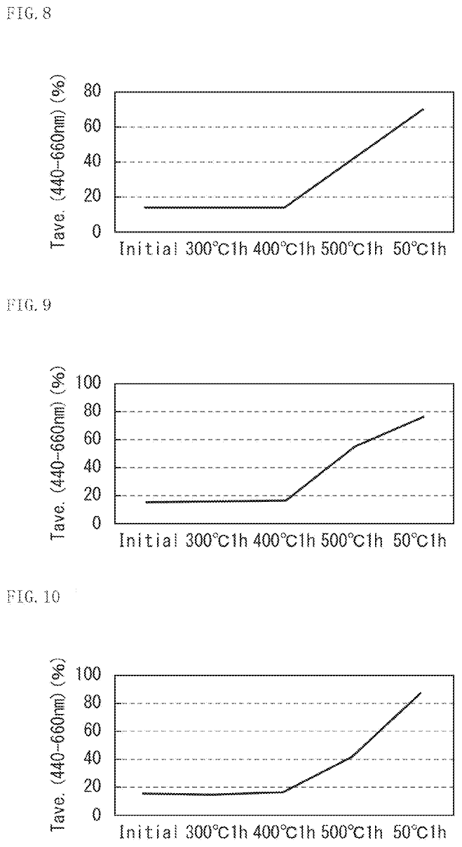

FIG. 6 illustrates change in transparentization of a bonding layer by respective annealing conditions in Example 1. In Example 1 in which films of Ti (lower layer)/Cu (upper layer) as metal layers were each formed with a thickness of 1 nm in this order, average transmittance by annealing treatment at 300° C. for 1 h was 95%, and the average transmittance was hardly changed even in a case where the treatment was performed at a higher temperature for a longer time. FIG. 7 illustrates change in transparentization of a bonding layer by respective annealing condition in Example 2. In Example 2 in which films of Ti (lower layer)/Cu (upper layer) as the metal layers were each formed with a thickness of 5 nm in this order, average transmittance by annealing treatment at 500° C. for 1 h was 90% or more. FIG. 8 illustrates change in transparentization of a bonding layer by respective annealing conditions in Example 3. FIG. 9 illustrates change in transparentization of a bonding layer by respective annealing conditions in Example 4. FIG. 10 illustrates change in transparentization of a bonding layer by respective annealing conditions in Example 5. It is appreciated that the metal layer that bonds the pair of synthetic quartz substrates is not limited to Cu, and it is also possible to transparentize Pt, Au, and Ni by annealing treatment.

Although the present disclosure has been described above with reference to some embodiments, the modification example, and the examples, the present disclosure is not limited to modes described in the embodiments and the like described above, and may be modified in a variety of ways. For example, it is not necessary to include all components described in the embodiments and the like described above, or any other component may be further included.

In addition, the thicknesses and materials of the components described above are examples, and not limited to those described above.

It is to be noted that the effects described herein are merely illustrative and non-limiting, and other effects may be included. For example, in the embodiments and the like described above, optical parts such as a cemented lens and a prism have been described as application examples of the present technology; however, the application example of the present technology is not limited thereto. For example, the technology is applicable to, for example, an exterior casing such as a smartphone, a watch, and a watch type wearable device.

It is to be noted that the present disclosure may have the following configurations. According to the present technology having the following configurations, an oxygen supply layer including an oxide material, a second metal layer including a second metal element having a free energy of oxide formation smaller than −330 (kJ/mol of compounds) at room temperature, and a first metal layer including a first metal element having a free energy of oxide formation of −330 (kJ/mol of compounds) or more at room temperature and a self-diffusion coefficient of 1×10⁻⁵⁵ (m²/s) or more at room temperature are formed in order on each of one surface (a bonding surface) of a first base and one surface (a bonding surface) of a second base, the first metal layers on side of the first base and side of the second base are superimposed on each other, and heating and pressurization are performed in the atmosphere. Accordingly, replacement and diffusion occur between the second metal layer and the first metal layer, and the second metal element is oxidized by oxygen released from the oxygen supply layer to transparentize a bonding layer. This makes it possible to achieve lower cost and improve alignment properties.
(1)

A structure including:
a first base;
a second base disposed to be opposed to the first base; and
a bonding layer that is provided between the first base and the second base, and includes a layer including, in a layer, a first metal element and a second metal element, the first metal element having a free energy of oxide formation (ΔG) of −330 (kJ/mol of compounds) or more at room temperature and a self-diffusion coefficient (D) of 1×10⁻⁵⁵ (m²/s) or more at room temperature, and the second metal element having a free energy of oxide formation at room temperature smaller than the free energy of oxide formation at the room temperature of the first metal element.
(2)

The structure according to (1), in which the first metal element further has a free energy of oxide formation (ΔG) of less than −10.68 (kJ/mol of compounds) at the room temperature and a self-diffusion coefficient (D) of less than 8.3×10⁻³⁸ (m²/s) at the room temperature.
(3)

The structure according to (1) or (2), in which the layer includes an oxide of the second metal element, and the first metal element is diffused into the oxide.
(4)

The structure according to (3), in which the bonding layer further includes an oxygen supply layer that supplies oxygen to the second metal element.
(5)

The structure according to (4), in which the first metal element is diffused to the oxygen supply layer.
(6)

The structure according to any one of (1) to (5), in which the bonding layer has light transmittance.
(7)

The structure according to any one of (1) to (6), in which the first metal element includes an element of one of nickel (Ni), palladium (Pd), platinum (Pt), copper (Cu), silver (Ag), gold (Au), and zinc (Zn).
(8)

The structure according to any one of (1) to (7), in which the second metal element includes one of scandium (Sc), titanium (Ti), vanadium (V), chromium (Cr), yttrium (Y), zirconium (Zr), niobium (Nb), molybdenum (Mo), lanthanum (La), cerium (Ce), hafnium (Hf), tantalum (Ta), tungsten (W), aluminum (Al), and silicon (Si).
(9)

The structure according to any one of (4) to (8), in which the oxygen supply layer includes a layer including silicon oxide.
(10)

The structure according to any one of (1) to (9), in which the first base has light transmittance.
(11)

The structure according to any one of (1) to (10), in which the second base has light transmittance.
(12)

A method of manufacturing a structure including:
forming an oxygen supply layer including an oxide material on each of one surface of a first base and one surface of a second base;
forming a second metal layer including a second metal element on each of the oxygen supply layer on side of the first base and the oxygen supply layer on side of the second base, the second metal element having a free energy of oxide formation (ΔG) smaller than −330 (kJ/mol of compounds) at room temperature;
forming a first metal layer including a first metal element on each of the second metal layer on the side of the first base and the second metal layer on the side of the second base, the first metal element having a free energy of oxide formation (ΔG) of −330 (kJ/mol of compounds) or more at room temperature and a self-diffusion coefficient (D) of 1×10⁻⁵⁵ (m²/s) or more at room temperature; and
superimposing the first metal layers on the side of the first base and the side of the second base and performing heating and pressurization in the atmosphere.
(13)

The method of manufacturing the structure according to (12), in which the heating and the pressurization cause the first metal element included in the first metal layer to be replaced by the second metal element included in the second metal layer, and cause the first metal element to be diffused to the second metal layer.
(14)

The method of manufacturing the structure according to (12) or (13), in which the heating and the pressurization cause the second metal element included in the second metal layer to be oxidized by oxygen released from the oxygen supply layer.
(15)

The method of manufacturing the structure according to any one of (12) to (14), in which the oxygen supply layer is formed to have a surface having arithmetic mean roughness (Ra) of <1 nm or less.
(16)

The method of manufacturing the structure according to any one of (12) to (15), in which after the oxygen supply layer is formed, a surface of the oxygen supply layer is polished to arithmetic mean roughness (Ra) of <1 nm or less.
(17)

The method of manufacturing the structure according to any one of (12) to (16), in which the first metal layers provided on the side of the first base and the side of the second base are put together, and the heating and the pressurization are performed in the atmosphere, and thereafter, heating treatment is performed at a higher temperature.
(18)

A structure including:
a first base;
a second base disposed to be opposed to the first base; and
a bonding layer that is provided between the first base and the second base, and includes an oxide layer into which a metal element is diffused, the metal element having a free energy of oxide formation (ΔG) of −330 (kJ/mol of compounds) or more at room temperature and a self-diffusion coefficient (D) of 1×10⁻⁵⁵ (m²/s) or more.
(19)

The structure according to (18), in which the oxide layer includes a silicon oxide layer.

This application claims the priority on the basis of Japanese Patent Application No. 2021-019787 filed on Feb. 10, 2021 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A structure, comprising:
a first base;
a second base disposed to be opposed to the first base; and
a bonding layer that is provided between the first base and the second base, and includes, in a layer, a layer including a first metal element and a second metal element, the first metal element having a free energy of oxide formation (ΔG) of −330 (kJ/mol of compounds) or more at room temperature and a self-diffusion coefficient (D) of 1×10⁻⁵⁵ (m²/s) or more at room temperature, and the second metal element having a free energy of oxide formation (ΔG) at room temperature smaller than the free energy of oxide formation (ΔG) at the room temperature of the first metal element.

2. The structure according to claim 1, wherein the first metal element further has a free energy of oxide formation (ΔG) of less than −10.68 (kJ/mol of compounds) at the room temperature and a self-diffusion coefficient (D) of less than 8.3×10⁻³⁸ (m²/s) at the room temperature.

3. The structure according to claim 1, wherein the layer includes an oxide of the second metal element, and the first metal element is diffused into the oxide.

4. The structure according to claim 3, wherein the bonding layer further includes an oxygen supply layer that supplies oxygen to the second metal element.

5. The structure according to claim 4, wherein the first metal element is diffused to the oxygen supply layer.

6. The structure according to claim 1, wherein the bonding layer has light transmittance.

7. The structure according to claim 1, wherein the first metal element comprises an element of one of nickel (Ni), palladium (Pd), platinum (Pt), copper (Cu), silver (Ag), gold (Au), and zinc (Zn).

8. The structure according to claim 1, wherein the second metal element comprises one of scandium (Sc), titanium (Ti), vanadium (V), chromium (Cr), yttrium (Y), zirconium (Zr), niobium (Nb), molybdenum (Mo), lanthanum (La), cerium (Ce), hafnium (Hf), tantalum (Ta), tungsten (W), aluminum (Al), and silicon (Si).

9. The structure according to claim 4, wherein the oxygen supply layer comprises a layer including silicon oxide.

10. The structure according to claim 1, wherein the first base has light transmittance.

11. The structure according to claim 1, wherein the second base has light transmittance.

12. A method of manufacturing a structure, comprising:
forming an oxygen supply layer including an oxide material on each of one surface of a first base and one surface of a second base;
forming a second metal layer including a second metal element on each of the oxygen supply layer on side of the first base and the oxygen supply layer on side of the second base, the second metal element having a free energy of oxide formation (ΔG) smaller than −330 (kJ/mol of compounds) at room temperature;
forming a first metal layer including a first metal element on each of the second metal layer on the side of the first base and the second metal layer on the side of the second base, the first metal element having a free energy of oxide formation (ΔG) of −330 (kJ/mol of compounds) or more at room temperature and a self-diffusion coefficient (D) of 1×10⁻⁵⁵ (m²/s) or more at room temperature; and
superimposing the first metal layers on the side of the first base and the side of the second base and performing heating and pressurization in the atmosphere.

13. The method of manufacturing the structure according to claim 12, wherein the heating and the pressurization cause the first metal element included in the first metal layer to be replaced by the second metal element included in the second metal layer, and cause the first metal element to be diffused to the second metal layer.

14. The method of manufacturing the structure according to claim 12, wherein the heating and the pressurization cause the second metal element included in the second metal layer to be oxidized by oxygen released from the oxygen supply layer.

15. The method of manufacturing the structure according to claim 12, wherein the oxygen supply layer is formed to have a surface having arithmetic mean roughness (Ra) of <1 nm or less.

16. The method of manufacturing the structure according to claim 12, wherein after the oxygen supply layer is formed, a surface of the oxygen supply layer is polished to arithmetic mean roughness (Ra) of <1 nm or less.

17. The method of manufacturing the structure according to claim 12, wherein the first metal layers provided on the side of the first base and the side of the second base are put together, and the heating and the pressurization are performed in the atmosphere, and thereafter, heating treatment is performed at a higher temperature.
